(19) United States
(12) Patent Application Publication
(10) Pub. No.: US 2016/0185190 A1
(43) Pub. Date: Jun. 30, 2016

(54) Infill Panel for Vehicle Window

(71) Applicant: HA-DE INNOVATIONS PTY LTD, Aitkenvale, Queensland (AU)

(72) Inventors: Desley Lee Thomas, Aitkenvale, Queensland (AU); David John Harris, Aitkenvale, Queensland (AU)

(73) Assignee: Ha-De Innovations Pty Ltd, Aitkenvale, Queensland (AU)

(21) Appl. No.: 14/912,182

(22) PCT Filed: Aug. 12, 2014
(86) PCT No.: PCT/AU2014/050179

§ 371 Date: Feb. 16, 2016

(30) Foreign Application Priority Data
Aug. 13, 2013 (AU) 2013903045

(51) Int. Cl. B60J 1/20; B60R 99/00; B60J 1/08

(52) U.S. Cl. CPC B60J 1/2094; B60J 1/085; B60R 99/00

(57) ABSTRACT

An infill panel for a vehicle window, the vehicle window having a surround and a movable window panel with at least one edge, the infill panel including a gas permeable portion, a receiving portion to receive at least one edge of the movable window panel and at least one edge portion receivable at least partially into the vehicle window surround.

### TECHNICAL FIELD

The present invention relates to vehicle accessories and particularly to shields, shades and panels relating to vehicle windows.

### BACKGROUND ART

The ability to have a vehicle window in a partially opened condition to allow air to circulate through the vehicle but to provide a barrier screen against unauthorized access to the vehicle as well as keeping out pests, in the form of insects, animals or humans can be important,

This allows the internal temperature of the vehicle to remain relatively close to ambient as well as to allow air flow through the vehicle whilst keeping unwanted visitors outside.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an infill panel for a vehicle window, which may at least partially overcome at least one of the abovementioned disadvantages or provide the consumer with a useful or commercial choice.

With the foregoing in view, the present invention in one form, resides broadly in an infill panel for a vehicle window, the vehicle window having a surround and a movable window panel with at least one edge, the infill panel including a gas permeable portion, a receiving portion to receive at least one edge of the movable window panel and at least one edge portion receivable at least partially into the vehicle window surround.

In use, the movable vehicle window panel is typically moved to a partially open condition and the receiving portion of the infill panel is engaged with the at least one edge of the window panel whilst the at least one edge of the infill panel is aligned with the window surround, and the movable window panel is then moved towards the closed position until the infill panel is clamped between the window panel and the surround.

The infill panel of the present invention is therefore adapted to be located and to fit between a partially lowered (or partially raised) window member and the surround frame of the window.

The panel of the present invention is typically particularly adapted for use with windows that are raised and lowered but may be used on windows that are opened/closed in any direction, using any mechanism.

The infill panel of the present invention is not limited to a continuous panel and for example, the infill panel may be or include a panel with openings therein such as mesh, either partially or completely.

Typically, where a window panel is partially open, an opening will be defined between the movable window panel and the surround frame. Typically though not always, when dealing with a vehicle window that can be opened, the window is located in a movable panel such as a door or tailgate with an integral surround frame extending therefrom. However, the surround frame does not necessarily have to be provided as a part of a movable panel and could for example be provided as a fixed panel with the movable panel movable relative thereto. This type of door or tailgate is normally known as a “frameless” door or tailgate.

Nor does the window have to be located in a movable panel such as a door or tailgate but may be in a fixed panel of the vehicle.

The infill panel is shaped to occupy a particular shaped opening and have the window panel moved to allow installation and removal of the infill panel as well as to ensure that the infill panel is correctly located to fill the opening.

The infill panel of the present invention can be used with any vehicle that has movable windows including automobiles or cars and trucks in particular. Indeed, the infill panel can be used with any vehicle in relation to which a user may require a window open but secure to selectively allow gases such as air to move between the inside and outside of the vehicle and/or to prevent ingress or egress of objects or life forms.

The vehicle window will normally be in a door of vehicle. The window normally has a movable window panel. The window will normally have a surround frame extending from the upper side of the door and defining an opening which is normally the opening in which the movable window panel is located and movable.

The movable window panel is adapted to be moved relative to the surround frame to close the window or to open the window at a variety of open positions. Normally, the movable window panel is raised and lowered relative to the vehicle panel to which the window panel is mounted.

The surround frame is typically defined by an upper surround frame member and at least a pair of side surround frame members. Each of the members is typically substantially U-shaped or has a U-shaped opening therein, with the U-shaped opening facing inwardly towards the centre of the opening in which the movable window panel moves.

There may be one or more seals provided on the surround frame members and typically, a seal is provided at least on the inside and/or the outside to abut the edge of the window panel during movement of the window panel as well as when the window panel is closed, to seal the window.

The infill panel of the present invention has a gas permeable portion. Normally, the gas permeable portion is provided as a mesh portion. Typically, the mesh portion has a regular array of openings provided therethrough. It is particularly preferred that the openings are formed by punching billets or blanks out of a unitary panel rather than forming the preferred mesh portion by weaving strands to form mesh.

It is particularly preferred that the mesh be formed from a metal material in order to provide the infill panel with the ability to secure the window and to minimize or prevent forced entry through the mull panel. A particularly preferred material is stainless steel. The material can be coated with one or more coats of any material in order to provide the infill panel with particular properties such as rust resistance or to provide a particular colour.

One particularly preferred method of forming the mesh panel is through the use of punching as outlined above or through the use of expanded mesh which is typically formed by cutting or incising a line or array into a unitary panel and then applying a tension force to either end of the sheet in order to expand openings from the cuts or incisions.

The preferred mesh material used may be flexible but is preferably rigid.

The openings in the preferred mesh material are typically sized to prevent insects, even small insects, passing through the mesh material. The openings may be sized and/or shaped in order to prevent insects passing in either direction but preferably at least inwardly.

Normally, a continuous mesh panel is provided as an upper portion of the infill panel. A lower edge portion of the preferred mesh panel is typically partially received in the receiving portion and preferably fixed therein.

It is also preferred that the mesh panel is associated with the receiving portion using a mechanism by which rattling of the mesh panel relative to the receiving portion is limited or prevented entirely.

The infill panel of the present invention also includes a receiving portion to receive at least one edge of the movable window panel. According to a particularly preferred embodiment, the receiving portion is configured as a substantially rigid, substantially H-shaped (cross-sectional shape) member or members.

The receiving portion is typically configured as one or more members which extend across the bottom of the infill panel according to a preferred embodiment. Preferably, the receiving portion will have an inner channel oriented towards the centre of the gas permeable portion of the infill panel and an outer channel oriented in an opposite direction to the inner channel.

Each channel is preferably defined by a pair of sidewalls and one side of a separating wall extending substantially transversely to the pair of sidewalls.

Preferably, the inner channel receives an edge of the gas permeable portion. Typically, the edge of the gas permeable portion will be fixed relative to the inner channel, typically therein or through. The fixture may be according to any mechanism.

Preferably, the outer channel is operable to receive the at least one edge of the movable window panel of the vehicle. Generally, the outer channel receives an upper and/or forward edge of the movable window panel depending upon the shape of the movable window panel.

Preferably, the shape of the receiving portion may vary depending upon whether the infill panel is adapted for use with a front or forward window of vehicle or a rear window of vehicle. Typically, the front or forward window of the vehicle has a substantially planar upper edge with a downwardly sloping forward portion. Therefore, the receiving portion adapted for use with the front or forward window of the vehicle normally has a substantially planar first portion and an angled portion. Typically, the angled portion is provided at a forward end thereof.

Typically, a rear window of the vehicle has a planar upper edge. Therefore, the receiving portion adapted for use with a rear window of a vehicle has a substantially planar first portion.

In both cases however, the movable window panel is typically arcuate when viewed from above. Therefore, the receiving portion will typically correspond in shape to the shape of the movable window panel.

The receiving portion is shaped to fit both the window panel and to be received within the window surround. The receiving portion preferably extends entirely across the bottom of the gas permeable portion. One or more seals may be provided in one or both of the inner and outer channels.

It is particularly preferred that the lower channel has at least one seal and/or cushioning member in order to protect the upper edge of the movable window panel. If a resilient member is provided, it can function as both the cushioning member and a sealing member.

The infill panel of the present invention also includes at least one edge portion receivable at least partially into the vehicle window surround. Typically, the at least one edge portion will be provided on the gas permeable portion. Typically, the gas permeable portion will extend past the periphery of the receiving portion in order to be received at least partially in the window surround and to allow the receiving portion to abut the window surround.

Normally, a cover or similar will be provided to cover the edge of the gas permeable portion in order to limit or prevent damage from the preferred rigid gas permeable portion which may be sharp or dangerous.

The edge portion of the infill panel may be rigid in order to define the shape of the gas permeable portion if provided in the flexible configuration but preferably, with a rigid gas permeable portion, the edge portion is preferably slightly resilient.

It is also preferred that the edge portion be slightly bulbous in shape as this may act to create a tactile and/or audible feedback mechanism to indicate when the edge portion is properly fitted within the window surround.

It is preferred that the edge portion extending continuously about the gas permeable portion. One preferred form of edge portion is or includes a plastic or rubber compound shaped over the edge of the gas permeable portion.

According to an alternative form, the receiving portion of the present invention may have a particular configuration which adapts the receiving portion more particularly to receiving and holding the gas permeable portion, particularly when provided as a mesh portion.

According to a particularly preferred embodiment, it is preferred that the inner channel is provided with at least one, and preferably a pair of opposed flaps in order to better seal against the gas permeable portion. The flaps will preferably be provided within the channel, typically of opposed side walls of the channel and extending inwardly towards the centre of the channel.

It is also preferred that the inner channel be provided with a clamp reinforcing structure or assembly. It is preferred that the clamp reinforcing structure or assembly be provided within each of the sidewalls of the inner channel. It is further preferred that the clamp reinforcing structure or assembly extend at least partially into and preferably through the separating wall of the inner channel.

In a particularly preferred embodiment, the clamp reinforcing structure or assembly will include an array of members extending within one sidewall of the inner channel, across a portion of the separating wall of the inner channel and upwardly into the other sidewall of the inner channel. Preferably the members may be formed from a single elongate member which is shaped to form each of the members in the array. Typically, there will be a plurality of members in one sidewall and a plurality of members in the opposite side wall with the members of one sidewall linked to the members on the opposite side wall through the separating wall.

According to a most preferred embodiment, the array of members will be formed from a single elongate wire, preferably of a metallic material which is then shaped into a number of loop members within each of the sidewalls. The array of members will normally extend upwardly within the respective sidewalls of the inner channel above the level of the preferred flap members provided within the channel.

Provision of the clamp reinforcing structure or assembly will allow the gas permeable portion to be inserted within the inner channel and then the sidewalls compressed against the as permeable portion in order to hold the gas permeable portion. The provision of the metallic clamp reinforcing structure or assembly will resist deformation and thereby act to hold the gas permeable portion more securely.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 is a schematic side view of an infill panel according to a preferred embodiment of the present invention.

FIG. 2 is a schematic sectional view of the infill panel illustrated in FIG. 1 along line A-A.

FIG. 3 is a schematic side view of a vehicle door with the infill panel illustrated in FIG. 1 fitted thereto.

FIG. 4 is a photograph of a prototype panel according to a preferred embodiment.

FIG. 5 is an end view of a receiving portion according to a preferred embodiment of the present invention.

FIG. 6 is a sectional side elevation view of the receiving portion illustrated in FIG. 5 along line B-B.

### DESCRIPTION OF EMBODIMENTS

According to a particularly preferred embodiment of the present invention, an infill panel 10 for a vehicle window is provided.

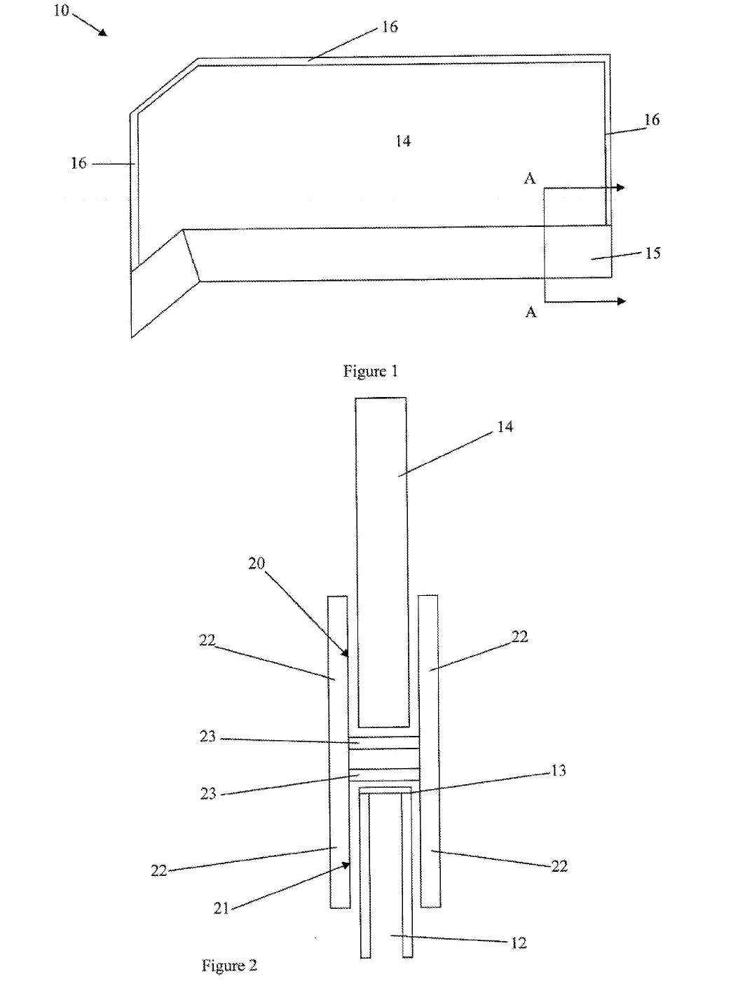

According to the preferred embodiment illustrated in FIGS. 1 and 4 in particular, the vehicle window normally has a surround 11 and a movable window panel 12 with at least one upper edge 13. The infill panel 10 of the preferred embodiment includes a gas permeable portion 14, a receiving portion 15 to receive an edge 13 of the movable window panel 12 and an edge portion 16 receivable at least partially into the vehicle window surround 11.

In use, the movable vehicle window panel 12 is moved to a partially open condition and the receiving portion 15 of the infill panel 10 is engaged with the upper edge 13 of the window panel 12 whilst the edge of the infill panel 10 is aligned with the window surround 11, and the movable window panel 12 is then moved towards the closed position until the infill panel 10 is clamped between the window panel 12 and the surround 11.

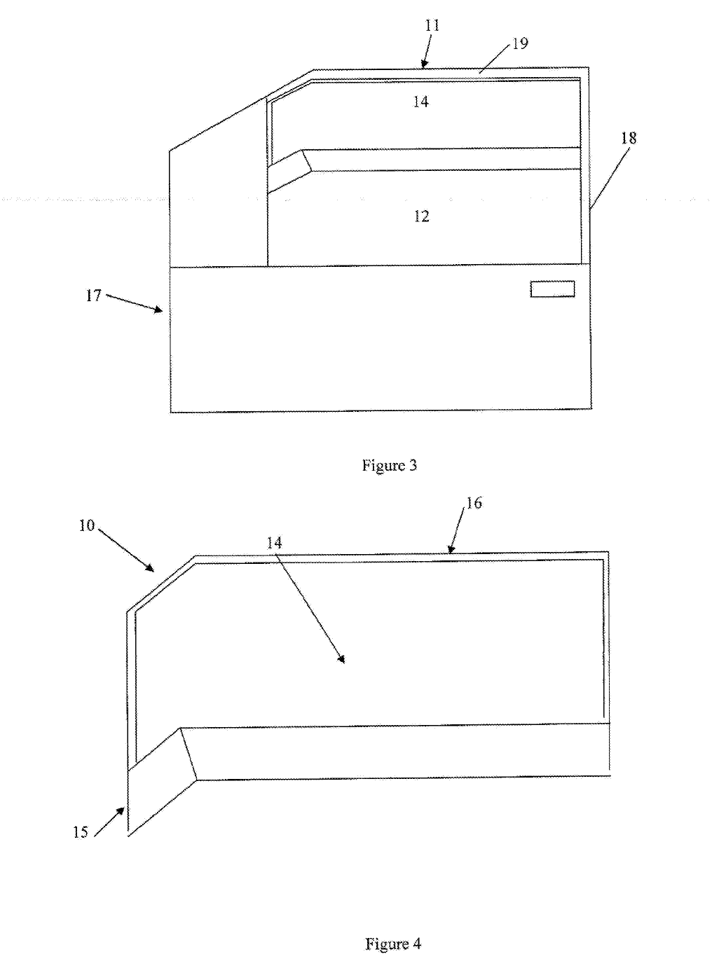

The infill panel of the present invention is therefore adapted to be located and to fit between a partially lowered (or partially raised) window member and the surround frame of the window as illustrated schematically in FIG. 3.

The infill panel 10 is shaped to occupy a particular shaped opening and have the window panel 12 moved to allow installation and removal of the infill panel 10 as well as to ensure that the infill panel 10 is correctly located to fill the opening.

The vehicle window will normally be in a door 17 of vehicle such as that illustrated in FIG. 3. The window normally has a movable window panel 12 which can be moved up and down as a user's discretion. The window will normally have a surround frame 11 extending from the upper side of the door 17 and defining an opening which is normally the opening in which the movable window panel 12 is located and movable. In the embodiment illustrated in FIG. 3, the surround frame has a rear vertical member 18, and an upper member 19 with a downwardly angled forward end.

The movable window panel 12 is adapted to be moved relative to the surround frame 11 to close the window or to open the window at a variety of open positions. Normally, the movable window panel 12 is raised and lowered relative to the door to which the window panel 12 is mounted.

Each of the surround frame members 18, 19 has a U-shaped opening therein, with the U-shaped opening facing inwardly towards the centre of the opening in which the movable window panel 12 moves.

The infill panel of the present invention has a gas permeable portion 14 which in the preferred embodiment is a mesh portion having a regular array of openings provided therethrough. It is particularly preferred that the openings are formed by punching billets or blanks out of a unitary panel rather than forming the preferred mesh portion by weaving strands to form mesh.

The mesh of the preferred embodiment is formed from a metal material in order to provide the infill panel 10 with the ability to secure the window and to minimize or prevent forced entry through the infill panel. A particularly preferred material is stainless steel. The material can be coated with one or more coats of any material in order to provide the infill panel with particular properties such as rust resistance or to provide a particular colour.

The preferred mesh material used is rigid.

The openings in the mesh material are typically sized to prevent insects, even small insects, passing through the mesh material.

As illustrated, a continuous mesh panel is provided as an upper portion of the infill panel 10. As illustrated in FIG. 2, a lower edge portion of the mesh panel 14 is partially received in the receiving portion 16 and preferably fixed therein.

According to the particularly preferred embodiment illustrated in FIG. 2, the receiving portion 16 is configured as a substantially rigid, substantially H-shaped (cross-sectional shape) member.

A pair of members are used in the illustrated embodiments to form a receiving portion which extend across the bottom of the infill panel 10 according to a preferred embodiment. The receiving portion 16 has an inner channel 20 oriented towards the centre of the mesh portion 14 of the infill panel 10 and an outer channel 21 oriented in an opposite direction to the inner channel 20.

Each channel 20, 21 is defined by a pair of sidewalls 22 and a separating wall 23 extending substantially transversely to the pair of sidewalls 22.

As illustrated in FIG. 2, the inner channel 20 receives an edge of the mesh portion 14. Typically, the edge of the mesh portion 14 will be fixed relative to the inner channel 20, typically therein or through. The fixture may be according to any mechanism.

The outer channel 21 is operable to receive the edge 13 of the movable window panel 12 of the vehicle. Generally, the outer channel 21 receives an upper and/or forward edge of the movable window panel 12 depending upon the shape of the movable window panel 12.

The shape of the receiving portion may vary depending upon whether the infill panel 10 is adapted for use with a front or forward window of vehicle or a rear window of vehicle. Typically, the front or forward window of the vehicle has a substantially planar upper edge with a downwardly sloping forward portion. Therefore, the receiving portion adapted for use with the front or forward window of the vehicle normally has a substantially planar first portion and an angled portion. Typically, the angled portion is provided at a forward end thereof. This configuration is illustrated in the Figures.

Typically, a rear window of the vehicle has a planar upper edge. Therefore, the receiving portion adapted for use with a rear window of a vehicle has a substantially planar first portion.

In both eases however, the movable window panel 12 is typically arcuate when viewed from above. Therefore, the receiving portion 15 will typically correspond in shape to the shape of the movable window panel 12.

The receiving portion 15 is shaped to fit both the window panel 12 and to be received within the window surround 11. The receiving portion 15 preferably extends substantially but not entirely across the bottom of the mesh portion as can be seen in FIG. 4. Typically, the mesh portion 14 extends past the periphery of the receiving portion 16 in order to be received at least partially in the window surround 11 and to allow the receiving portion 15 to abut the window surround.

The infill panel 10 of the preferred embodiment also includes an edge portion 16 receivable at least partially into the vehicle window surround 15. Typically, the edge portion 16 is provided on the mesh portion 14.

With a rigid mesh portion such as that illustrated in FIG. 4, the edge portion 16 is preferably slightly resilient and slightly bulbous in shape as this may act to create a tactile and/or audible feedback mechanism to indicate when the edge portion 16 is properly fitted within the window surround.

It is preferred that the edge portion 16 extend continuously about the mesh portion 14. One particularly preferred form of edge portion 16 is or includes a plastic or rubber compound shaped over the edge of the mesh portion 14.

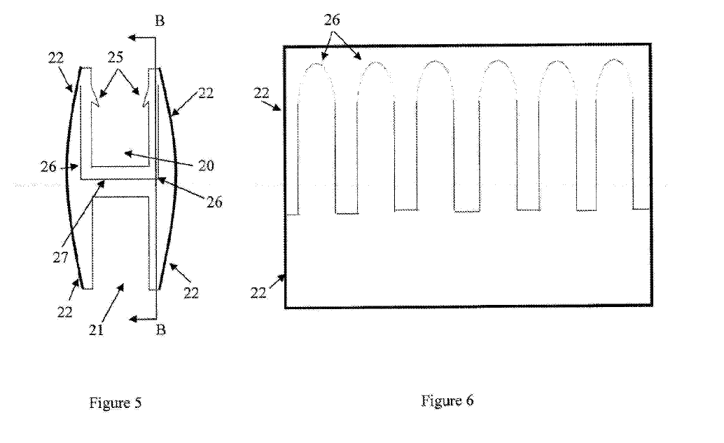

According to a more preferred form illustrated in FIGS. 5 and 6, the receiving portion 15 has a pair of opposed flaps 25 in order to better seal against the gas permeable portion 14. As illustrated, the flaps 25 are provided within the inner channel 20, on opposed side walls 22 of the inner channel 20 and extending inwardly towards the centre of the channel 20.

The inner channel 20 is also provided with a clamp reinforcing structure of assembly, including an array of loop members 26 extending within one sidewall 22 of the inner channel 20, a connector portion 27 extending across a portion of the separating wall 23 of the inner channel 20 and upwardly into the other sidewall 22 of the inner channel 20. The clamp reinforcing structure or assembly of the illustrated embodiment is formed from a single elongate wire member which is shaped to form each of the loop members 26 in the array and also extend from a loop member 26 on one sidewall 22, across the separating wall 23 and form a loop member 26 on the other sidewall before extending back across the separating wall 23 to form a loop member 26. In this way, a single member can form a plurality of members in one sidewall and a plurality of members in the opposite side wall with the members of one sidewall linked to the members on the opposite side wall through the separating wall.

Provision of the clamp reinforcing structure or assembly will allow the gas permeable portion 14 to be inserted within the inner channel 20 and then the sidewalls 22 compressed against the gas permeable portion 14 in order to hold the gas permeable portion 14. The provision of the metallic clamp reinforcing structure or assembly will resist deformation and thereby act to hold the gas permeable portion more securely.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An infill panel for a vehicle window, the vehicle window having a surround and a movable window panel with at least one edge, the infill panel including:
a gas permeable portion having a plurality of apertures sized to prevent the ingress of insects through the vehicle window,
a receiving portion to receive at least one edge of the movable window panel and at least one edge of the gas permeable portion, and
at least one edge portion receivable at least partially into the vehicle window surround,
wherein the receiving portion directly receives at least one edge of the moveable window panel, and
wherein the receiving portion and at least one edge portion are manufactured separately.

2. The infill panel for a vehicle window according to claim 1 wherein the receiving portion is mounted to the gas permeable portion along a lower portion of the gas permeable portion.

3. The infill panel for a vehicle window according to claim 1 wherein the gas permeable portion is provided as a mesh portion.

4. The infill panel for a vehicle window according to claim 3 wherein the mesh portion is formed from a metal material to provide the infill panel with the ability to secure the window and to minimize or prevent forced entry through the infill panel.

5. The infill panel for a vehicle window according to claim 3 wherein openings in the mesh portion are sized to prevent insects passing through the mesh material.

6. The infill panel for a vehicle window according to claim 3 wherein a continuous mesh panel is provided as an upper portion of the infill panel, and a lower edge portion of the mesh panel is partially received in the receiving portion and fixed therein.

7. An infill panel for a vehicle window as claimed in claim 6 wherein the receiving portion is configured as a substantially rigid, substantially H cross-sectional-shaped portion.

8. The infill panel for a vehicle window according to claim 7 wherein the receiving portion has an inner channel to receive an edge of the gas permeable portion and oriented towards the centre of the gas permeable portion of the infill panel and an outer channel oriented in an opposite direction to the inner channel operable to receive the at least one edge of the movable window panel of the vehicle.

9. The infill panel for a vehicle window according to claim 8 wherein each of the inner channel and the outer channel is defined by a pair of sidewalls and one respective side of a separating wall extending substantially transversely to the pair of sidewalls.

10. The infill panel for a vehicle window according to claim 8 wherein the inner channel is provided with at least one flap in order to better seal against the gas permeable portion.

11. The infill panel for a vehicle window according to claim 8 wherein the inner channel is provided with a clamp reinforcing assembly to damp the receiving portion to the gas permeable portion.

12. The infill panel for a vehicle window according to claim 11 wherein the clamp reinforcing assembly is provided within each of the respective sidewalls of the inner channel.

13. The infill panel for a vehicle window according to claim 12 wherein the clamp reinforcing assembly extends at least partially into the separating wall of the inner channel.

14. The infill panel for a vehicle window according to claim 13 wherein the clamp reinforcing assembly includes an array of members extending within one sidewall of the inner channel, across a portion of the separating wall of the inner channel and upwardly into the other sidewall of the inner channel.

15. The infill panel for a vehicle window according to claim 14 wherein the array of members is formed from a single elongate member shaped to form each of the members in the array.

16. The infill panel for a vehicle window according to claim 14 wherein the array of members extend upwardly within the respective sidewalls of the inner channel above the level of at least one flap member provided within the channel.

17. The infill panel for a vehicle window according to claim 16 wherein the receiving portion is a substantially unitary resilient member.
